(19) United States
(12) Patent Application Publication
(10) Pub. No.: US 2014/0272042 A1
(43) Pub. Date: Sep. 18, 2014

(54) SYSTEMS AND METHODS FOR PACKAGING FOOD PRODUCTS

(71) Applicant: Thomas D. Gillette, Wilmington, NC (US)

(72) Inventor: Thomas D. Gillette, Wilmington, NC (US)

(21) Appl. No.: 13/841,806

(22) Filed: Mar. 15, 2013

(51) Int. Cl. A23L 3/00

(52) U.S. Cl. CPC A23L 3/00
USPC 426/392

(57) ABSTRACT

Systems and methods for packaging food products, such as fruits, vegetables, and meats. Specifically, the described methods relate to systems and methods for packaging food products in a manner that increases the products' shelf life. Generally, the methods begin by providing a food product. In some cases, debris is removed from the food product. To kill bacteria and other microbes on the food product, the food product is optionally washed in ozonated water. To deactivate enzymes within the food product, the food product is heated, though not necessarily cooked or blanched. The food product is then typically sealed in a barrier package containing between about 1 percent and about 50 percent oxygen, by volume. In some cases, the sealed package is then heated to between about 165 and about 285 degrees Fahrenheit to kill microbes in the sealed package. Other implementations are also described.

### BACKGROUND OF THE INVENTION

1. Field of the Invention

The present invention relates to systems and methods for packaging food products. In particular, the present invention relates to systems and methods for packaging food products in a manner that increases the products' shelf life.

2. Background and Related Art

After fruits, vegetables, and other produce have been harvested, they are often sold to the public in a fresh state, or as close to a fresh state as possible. In such instances, the produce is typically left uncovered on a shelf, table, or other structure and then misted with water from time to time to prevent the produce from wilting and to otherwise keep the produce looking fresh.

Despite current misting techniques, however, some forms of fresh produce tend to have a relatively short shelf life. Indeed, because many types of fresh produce are typically subject to bacterial growth, fungal growth, attack by flies and other insects, dehydration, decomposition, and other damage, a relatively large amount of fresh produce spoils before it can be sold. As a result, the spoiled produce may need to be sold at a reduced price, if the produce can be sold at all. Indeed, due to spoilage, much of the produce harvested across the world is never eaten by humans and is ultimately wasted.

In an effort to increase produce shelf life, some have chosen to preserve produce in cans or jars. Through some such techniques, some produce can be made to last for one or more years. As another alternative, some have chosen to freeze produce and to sell it from a frozen-produce section of a store. In such cases, the frozen produce can have a shelf life that is several months longer than the shelf life of the same produce that is sold fresh. In either case, however, some consumers do not perceive frozen, canned, or bottled produce as being as appetizing as produce that is sold in the fresh produce section of a store. As a result, some consumers may prefer purchasing produce from the fresh produce section of a store, even though such produce may have a significantly shorter shelf life than the preserved produce.

Thus, while techniques currently exist that are used to package and preserve produce, challenges still exist, including those discussed above. Accordingly, it would be an improvement in the art to augment or even replace current techniques with other techniques.

### SUMMARY OF THE INVENTION

The present invention relates to systems and methods for packaging food products. In particular, the present invention relates to systems and methods for packing food products in a manner that increases the products' shelf life.

Implementation of the present invention takes place in association with food products, which may include, but is not limited to, fruits and vegetables. In this regard, the methods generally begin by providing a food product. In some cases, debris is removed from the food product through flotation washing, air cleaning, and/or any other suitable method for removing debris from food products. To kill bacteria and other microbes on the food product, the food product is optionally washed in an ozonated water solution. To deactivate enzymes within the food product, the product is heated (e.g., to obtain an internal temperature between about 155° Fahrenheit and about 235° Fahrenheit), though not necessarily cooked or blanched. The food product is then typically sealed in a barrier package containing between about 1 percent and about 50 percent oxygen, by volume. In some cases, the sealed package is then exposed to temperatures between about 165° and about 285° Fahrenheit to kill microbes in the sealed package. Once the sealed package has been heated, the package can be cooled and the packaged food product can be sold.

While the systems and methods of the present invention have proven to be particularly useful in the area of packaging fruits and vegetables, those skilled in the art can appreciate that the systems and methods can be used in a variety of different applications and in a variety of different areas of manufacture to yield packaged foodstuffs having an increased shelf life. In this regard, the described systems and methods can be used to package meats, cheeses, and any other suitable foodstuffs.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative embodiment of a method for packaging a food product to increase the product's shelf life;

FIG. 2 illustrates a cross-sectional view of a representative embodiment of a sealed barrier package containing the food product; and

FIG. 3 illustrates another representative embodiment of a method for packaging the food product.

### DETAILED DESCRIPTION OF THE INVENTION

The present invention relates to systems and methods for packaging food products. In particular, the present invention relates to systems and methods for packing food products in a manner that increases the products' shelf life.

Indeed, some embodiments of the described systems and methods provide techniques for increasing the shelf life of a food product, while allowing the product to have one or more characteristics (such as the appearance, texture, firmness, touch, smell, taste, and/or other characteristic) of fresh food products. Representative embodiments of the described methods for packaging food products, as well as a representative embodiment of an associated container, are shown in the Figures. Specifically, FIGS. 1 and 3 illustrate some embodiments of methods for packaging food products, and FIG. 2 illustrates an embodiment of a barrier package containing a food product, wherein the product has been packaged through one of the described methods. The methods shown in FIGS. 1 and 3 can be modified by rearranging, adding to, removing, and modifying the various portions of the methods in any suitable manner.

FIG. 1 shows that some embodiments of a method 10 for packaging food products begin at step 15 by providing a food product, which may be used herein to refer to one or more food products. In this regard, the food product can comprise any suitable foodstuff that can be packaged according to the methods described herein. Some non-limiting examples of food products include edible culinary fruits and/or botanical fruits, vegetables (i.e., the fruit, leaf, stem, root, sprout, or other edible portion of a plant), legumes, meats (e.g., chicken, beef, pork, turkey, fish, lamb, processed meats, etc.), proteins, edamame, cultivars, psuedocarps, pods, nuts, ears, cones, grains, seeds, and/or fungi (e.g., mushrooms, etc.) of all varieties. In some embodiments, however, the produce comprises fruits, vegetables, and/or mushrooms. Indeed, in one example, the food product is selected from lettuce, cabbage, peppers, squash, beans, peas, corn, carrots, spices, nuts, legumes, edamame, tomatoes, artichokes, melons, and/or any other edible fruit, vegetable, or mushroom.

Step 20 in FIG. 1 shows that some embodiments of the method 10 continue as one or more enzymes (e.g., amylases, pectinases, proteases, etc.) that can contribute to food spoilage are deactivated in the food product. In this regard, the term “in” may be used to refer to enzymes that are on, throughout, and/or in the food product. This enzyme deactivation step can be accomplished in any suitable manner that allows the food product's internal temperature to be raised to a high enough temperature and for a sufficient period of time to deactivate enzymes in the food product. Indeed, in some embodiments, enzymes in the food product are deactivated by exposing the food product to steam, microwave energy, conventional or novel high pressure processing techniques, and/or one or more hot liquids (e.g., hot water or a hot aqueous solution). Indeed, in one example, enzymes in the food product are deactivated as the food product is: exposed to steam on a steam belt, exposed to steam through exposure to jets of steam, placed in a perforated container (e.g., basket or colander) that is exposed to steam, and/or any other method that exposes the food product to steam. In another non-limiting example, enzymes in the food product are deactivated as the food product is exposed to heated water. In this example, the food product can be exposed to heated water in any suitable manner, including by placing the food product in a bath of heated water, a high pressure processing technique employing water, and/or spraying the food product with heated water.

Where the food product is heated in order to deactivate enzymes in the food product, the internal temperature of the food product can be raised to any suitable temperature that deactivates enzymes in the food product (“deactivation temperature”). In some embodiments, the food product is heated to obtain an internal temperature that is as high as a deactivation temperature selected from about 170° Fahrenheit, about 180° Fahrenheit, about 185° Fahrenheit, about 200° Fahrenheit, and about 235° Fahrenheit. In contrast, in some embodiments, the food product is heated to obtain an internal temperature that is as low as a deactivation temperature selected from about 145° Fahrenheit, about 160° Fahrenheit, about 165° Fahrenheit, about 175° Fahrenheit, and about 178° Fahrenheit. In still other embodiments, the internal temperature of the food product is raised to any combination or sub-range of the aforementioned deactivation temperatures. In one example, the food product is heated so that its internal temperature is between about 160° Fahrenheit and about 185° Fahrenheit (e.g., about 165° Fahrenheit±3° Fahrenheit).

When the internal temperature of the food product is heated to a deactivation temperature, the food product can be maintained at that deactivation temperature for any suitable amount of time that allows enzymes to be deactivated in the food product. In some embodiments, the food product is heated so that its internal temperature is kept within a suitable range of deactivation temperatures for more than an amount of time selected from about 0.5 seconds, about 10 seconds, about 15 seconds, and about 30 seconds. In contrast, in some embodiments, the food product is heated so that its internal temperature is kept within a suitable range of deactivation temperatures for less than about 15 minutes, about 3 minutes, about 90 seconds, about 60 seconds, and about 35 seconds. In still other embodiments, the internal temperature of the food product can be kept at a deactivation temperature for any combination or sub-range of the above-mentioned time periods. In one example, the food product is heated so that its internal temperature is maintained at a deactivation temperature for between about 15 and about 90 seconds (e.g., about 30 seconds±10 seconds).

Although in some embodiments, the food product is partially or completely cooked during the enzyme deactivation step, in other embodiments, the food product is not fully cooked or blanched. In still other embodiments, the food product is not cooked or blanched at all during the enzyme deactivation step. Thus, enzymes in the food product that promote spoilage can be deactivated, while the food product continues to have one or more characteristics of fresh food product (e.g., a fresh food appearance, texture, taste, smell, etc.).

In some embodiments, once the food product is removed from the heat that is used to deactivate enzymes in the food product, the food product is cooled (e.g., at ambient temperature; in a cooled chamber, such as a fridge; on a freezer belt, in a water bath; etc.) before and/or as the food product is placed in a package according to step 25. In such embodiments, cooling can stop or prevent the food product from being fully cooked. In other embodiments, however, the food product is preferably placed in the package (as shown at step 25), without giving the food product time to cool. In either case, however, step 25 shows the method 10 continues as the food product is sealed in a package.

The food product can be placed in any suitable package that is impermeable (or substantially impermeable) to oxygen and microbes (“barrier package”). Some non-limiting examples of such packages include clean bags, sleeves, sealable films, trays with film tops, pouches, wraps, films, and other containers comprising one or more barrier film materials. Indeed, in some embodiments, the barrier package comprises a barrier film that contains a material, such as polyethylene, polypropylene, polystyrene, and/or any other material that is capable of sealing a food product in accordance with the described methods. As an additional characteristic, some embodiments of the package comprise a material that is microwavable. Furthermore, some embodiments of the package, or a portion thereof (e.g., a window) comprise a transparent material to allow consumers to see the food product within the package.

In some embodiments, the package comprises a material having a relatively low oxygen transmission ratio (“OTR”). Indeed, in some embodiments, the package (e.g., barrier package) has an OTR that is less than about 1 to about 1,500. In other embodiments, the package has an OTR that is less than about 1 to 500. In other embodiments, the package has an OTR that is less than about 1 to about 150. In still other embodiments, the package has an OTR that is less than about 1 to about 100. In yet other embodiments, the package has any suitable OTR that falls within the aforementioned ranges (e.g., an OTR that is less than about 1 to about 50).

The package can be sealed in any suitable manner that allows the barrier package to be impermeable or substantially impermeable to oxygen and/or microbes. In this regard, some examples of suitable sealing methods include, but are not limited to, melting, adhesively connecting, mechanically sealing (e.g., via a zipper seal or polymer zipper), and/or otherwise sealing one or more edges of the package together. By way of illustration, FIG. 2 shows an embodiment in which the barrier package 30 comprises a barrier-film sleeve 45 that has been sealed shut by melting its edges 50 together. For reference, FIG. 2 further shows the sealed package 30 comprises food product 35 (e.g., asparagus stalks) that is disposed on a tray 40, wherein the food product and package were prepared according to the methods described herein.

In some embodiments, the oxygen content within the sealed package 30 is controlled. In this manner, enough oxygen can be maintained in the package to kill or inactivate some microorganisms (e.g., Clostridium botulinum, the microorganism that causes botulism), while the amount of oxygen (which can lead to spoilage) is reduced. In some embodiments, the oxygen content in the sealed package is lower than a concentration selected from about 50%, about 25%, about 10%, about 7%, about 5%, about 3.5%, and about 3%, by volume. In contrast, in some embodiments, the oxygen content in the sealed package is greater than a concentration selected from about 0%, about 0.5%, about 1%, about 1.5%, about 2%, and about 9%, by volume. In still other embodiments, the oxygen content in the sealed package falls in any suitable combination or sub-range of the above-mentioned concentrations. In one example, the oxygen concentration in the sealed package is between about 2 and about 3%, by volume (e.g., 2.5%±0.3%).

The oxygen content in the sealed package 30 can be controlled in any suitable manner. In one example, the oxygen content in the package is controlled by vacuum packing the package, while ensuring that a desired amount of oxygen is retained in the package. In another example, the oxygen content in the package is controlled by filling the package (at least partially) with a controlled atmosphere comprising the desired oxygen concentration and one or more inert gases, such as carbon dioxide and/or nitrogen. In still another example, the oxygen content of the sealed package is controlled by filling the package with a controlled atmosphere comprising the desired oxygen content.

While not shown in FIG. 1, once the package is sealed, the package can be chilled and otherwise prepared to be sold in a store. In this regard, while the package can be frozen and sold in the frozen food product section of a store, in some embodiments, the sealed package is refrigerated and sold in the fresh food product section of a store (e.g., next to bagged salads, fresh meats, and/or other refrigerated products).

As stated earlier, the described methods can be modified in any suitable manner that allows the shelf life of a food product packaged according to the described methods to be increased over the shelf life of the same food product that is sold “fresh”. By way of illustration, FIG. 3 shows a representative embodiment of a method 100 for packaging food product, wherein the method comprises several optional steps. In this regard, the method can comprise any suitable number of the optional steps (or the addition of any other suitable step that is not shown), in any suitable order.

FIG. 3 shows that after the method begins at step 105 by providing a food product, the method optionally continues as debris (e.g., dirt, rocks, sand, leaves, plant parts, insecticides, fertilizers, herbicides, insects, rodents, ferrous metals, non-ferrous metals, plastic, etc.) is removed from the food product. In this regard, debris can be removed from the food product in any suitable manner, including, without limitation, by passing the food product through a conventional air cleaner, a flotation washer (e.g., a flume, a continuous belt washer, etc.), a brush washer, a screening mechanism, a food product washer, sprayer, or a combination thereof.

FIG. 3 shows that, in some embodiments, the method 100 continues as the food product is optionally washed with ozonated water. While washing the food product with ozonated water can perform many functions, in some instances, the ozonated water kills microbes with which it comes in contact. In this manner, the ozonated water can kill microbes (e.g., bacteria, fungi, etc.) that may otherwise promote food decomposition or cause illness in the food product's consumer.

Where the food product is washed with ozonated water, the ozonated water can be applied to the food product in any suitable manner. In some instances, the food product is sprayed with, washed in, or otherwise exposed to the ozonated water.

The ozonated water can have any suitable concentration of ozone that allows the ozonated water to kill microbes on the food product. In some embodiments, the ozonated water has an ozone concentration selected from a concentration as high as about 2.6 parts per million (ppm), about 3 ppm, about 4 ppm, and about 5 ppm. In contrast, in some embodiments, the ozonated water has an ozone concentration as low as a concentration selected from about 1 ppm, about 2 ppm, about 2.3 ppm, and about 2.5 ppm. In still other embodiments, the ozone concentration in the ozonated water has any suitable combination or sub-range of the above-mentioned ozone concentrations. In one example, the ozone concentration in the ozonated water is between about 2 ppm and about 3 ppm (e.g., 2.5 ppm±0.3 ppm).

Where the food product is washed with ozonated water, the ozonated water can have any suitable temperature. Indeed, in some embodiments, the ozonated water is between about 35° Fahrenheit and about 85° Fahrenheit. In still other embodiments, the ozonated water is between about 40° Fahrenheit and about 65° Fahrenheit. In yet other embodiments, the ozonated water has any temperature or range of temperatures that falls within the aforementioned temperatures (e.g., about 45° Fahrenheit±10 degrees).

The food product can also be washed in the ozonated water for any suitable amount of time. In some embodiments, for instance, the food product is washed for between about 1 minute and about 1 hour. In other embodiments, the food product is washed in the ozonated water for between about 2 minutes and about 8 minutes. In still other embodiments, the food product is washed in the ozonated water for any suitable sub-range of the aforementioned time periods (e.g., about 4 minutes±2 minutes).

Moving on to step 120, FIG. 3 shows that some embodiments of the method 100 proceed as the food product is processed. In this regard, the food product can be processed in any suitable manner, including, without limitation, by being cut, diced, grated, shredded, chopped, peeled, or otherwise processed.

In some embodiments, the method 100 optionally includes adding one or more additives (e.g., flavoring agents, coloring agents, preservatives, texturizing agents, etc.), packets (e.g., seasoning packets, dressing packets, utensils, napkins, instructions, etc.), other foodstuff, etc. to the food product. By way of illustration, FIG. 3, at step 130, shows some embodiments that include flavoring the food product. While the food product can be flavored with any suitable flavoring agent, in some instances, the food product is flavored with one or more spices, seasonings, natural flavorings, nature-identical flavorings, artificial flavorings, or combination thereof. In one non-limiting example, green beans are flavored with a bacon, or a natural pork, flavor.

Where the food product is flavored, the food product can be flavored in any suitable manner and at any suitable point in the method 100. In some embodiments, however, the food product is flavored as the enzymes are deactivated (e.g., at step 125). Indeed, in one example, the enzyme deactivation step occurs as the food product is heated in a bath containing a flavoring agent. In this manner, enzymes in the food product can be deactivated and the food product can be flavored through a single heating step.

After the food product has been sealed in a barrier package 30, as shown at step 135, step 140 of FIG. 3 shows that, in some embodiments, the sealed package is exposed to relatively hot temperatures to kill microbes (e.g., bacteria, fungi, etc.) that may be sealed within the package (e.g., microbes that were: on the packaging before the food product was packaged, introduced with the atmosphere in the package, etc.).

Where the sealed package 30 is heated, the package can be heated in any suitable manner, including, without limitation, by exposing the package to steam or a hot bath, by placing the package in a heated container (e.g., an oven), or any other suitable method. In some embodiments, however, the package is preferably exposed to steam.

When the sealed package 30 is heated to kill microbes that are potentially present in the sealed package, the package can be heated or exposed to any suitable temperature (“post-sealing temperature”) that can kill the microbes. In some embodiments, the sealed package is exposed to a temperature as high as a temperature selected from about 215° Fahrenheit, about 220° Fahrenheit, about 230° Fahrenheit, about 240° Fahrenheit, and about 285° Fahrenheit. In other embodiments, the sealed package is exposed to a temperature as low as a temperature selected from about 165° Fahrenheit, about 180° Fahrenheit, about 190° Fahrenheit, about 200° Fahrenheit, and about 210° Fahrenheit. In still other embodiments, the sealed package can be exposed to any suitable combination or sub-range of the above-mentioned temperatures. In one example, the sealed package is exposed to post-sealing temperatures between about 200° Fahrenheit and about 220° Fahrenheit (e.g., 212° Fahrenheit±5° Fahrenheit).

When the sealed package is heated to kill microbes that may be found in the package, the package can be heated or exposed to a suitable post-sealing temperature for any suitable amount of time that allows microbes in the package to be killed. In some embodiments, the sealed package is exposed to a suitable post-sealing temperature range for more than an amount of time selected from about 30 seconds, about 2.5 minutes, about 4 minutes, about 6 minutes, and about 8 minutes. In contrast, in some embodiments, the sealed package is exposed to a suitable post-sealing temperature range for less than an amount of time selected from about 15 minutes, about 10 minutes, about 9 minutes, and about 8.5 minutes. In still other embodiments, the sealed package is exposed to a suitable post-sealing temperature range for any combination or sub-range of the above-mentioned time periods. In one example, the sealed package is exposed to a suitable range of the aforementioned post-sealing temperatures for a period of time between 6 minutes and about 9 minutes (e.g., about 8 minutes±30 seconds). Despite this post-sealing heat treatment step, in some embodiments, the food product in the sealed package is not fully cooked or blanched.

FIG. 3 shows that, in some embodiments, method 100 continues at step 145 as the sealed package 30 is chilled. While the package can be chilled any suitable time after being removed from the post-sealing temperature, in some embodiments, the package is chilled immediately (or quickly) after being removed from the post-sealing temperature. In this manner, the food product can be chilled to slow potential microbe proliferation and/or to stop, impede, or prevent any cooking process that may occur in the food product. Thus, in some embodiments, the food product is in a substantially clean, sealed package, but the food product is not fully cooked or blanched.

The sealed package can be chilled in any suitable manner, including, without limitation, by leaving the package at ambient temperature; cooling the package in a cool bath, freezer belt, and/or cooler; passing the sealed package through a series of colder baths, coolers, freezer belts, or other cooling mechanisms; etc. In some embodiments, the sealed package is cooled to a final temperature between about −5° Fahrenheit and about 50°Fahrenheit, or any sub-range thereof (e.g., between about 34° Fahrenheit and about 42° Fahrenheit). In this manner, the sealed package can be placed in a refrigerator or freezer for sale. A consumer can then eat the food product directly from the package, heat the food product (e.g., by microwaving, boiling, cooking, etc.), and/or otherwise prepare the food product before eating it.

In addition to the aforementioned characteristics, the described systems and methods can include several beneficial characteristics. In one example, food products packaged through the described methods can have a significantly longer shelf life than the similar foods product that are left completely fresh and unpackaged. For instance, a typical package of a food product treated according to the described methods can last about 1 to about 150 days longer than similar foods that are left fresh and unpackaged.

In another example, because the packaged food product can have a fresh-food appearance, the packaged food product may be more appetizing to consumers than is similar food that has been preserved in a can or jar.

Thus, as discussed herein, embodiments of the present invention embrace systems and methods for packaging food products. In particular, embodiments of the present invention relate to systems and methods for packing food products in a manner that increases the products' shelf life.

The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All changes that come within the meaning and range of equivalency of the claims are to be embraced within their scope. Furthermore, the term step may be used herein to refer to a portion of a method, but is not intended to delineate the beginning or the end of an element of a process, and is not intended to be limiting in any manner.

What is claimed is:

1. A method for packaging a food product, the method comprising:
providing a food product;
heating the food product to deactivate enzymes in the food product;
sealing the food product in a barrier package, wherein an internal cavity of the sealed package comprises between about 0.5 percent and about 50 percent oxygen, by volume.

2. The method of claim 1, wherein the heating to deactivate enzymes in the food product does not fully cook the food product.

3. The method of claim 1, wherein the enzyme deactivation comprises raising an internal temperature of the food product to between about 165 degrees Fahrenheit and about 235 degrees Fahrenheit.

4. The method of claim 3, wherein the heating to deactivate enzymes comprises exposing the food product to steam.

5. The method of claim 3, wherein the enzyme deactivation comprises placing the food product in a heated bath.

6. The method of claim 3, wherein the internal temperature of the food product is raised to between about 165 degrees Fahrenheit and about 235 degrees Fahrenheit for a period of time between about 15 and about 90 seconds.

7. The method of claim 1, wherein the internal cavity of the sealed package comprises between about 1 percent and about 10 percent oxygen, by volume.

8. The method of claim 1, further comprising exposing the sealed package to temperatures between about 165 degrees Fahrenheit and about 285 degrees Fahrenheit.

9. The method of claim 5, wherein the heated bath comprises a food product flavoring agent.

10. The method of claim 1, further comprising washing the food product with ozonated water before sealing the food product in the package.

11. A method for packaging a food product, the method comprising:
providing the food product;
removing debris from the food product;
heating the food product to deactivate enzymes in the food product;
sealing the food product in an airtight package, wherein an internal cavity of the sealed, airtight package comprises between about 1 percent and about 10 percent oxygen, by volume; and
exposing the sealed package to hot temperatures between about 165° Fahrenheit and about 285° Fahrenheit, before the food product in the sealed package is sent to market, in order to kill microbes in the sealed package.

12. The method of claim 11, wherein the heating to deactivate enzymes comprises raising an internal temperature of the food product to between about 165 and about 185 degrees Fahrenheit.

13. The method of claim 12, wherein the internal temperature is raised to between about 165 and about 185 degrees Fahrenheit for between about 30 seconds and about 90 seconds minutes.

14. The method of claim 11, wherein the internal cavity of the sealed, airtight package comprises between about 2 percent and about 3 percent oxygen, by volume.

15. The method of claim 11, further comprising, immediately cooling the sealed package, after the sealed package has been exposed to the hot temperatures.

16. The method of claim 11, further comprising washing the food product with ozonated water before sealing the food product in the airtight package, and wherein the ozonated water comprises ozone at a concentration between about 2 and about 5 parts per million.

17. The method of claim 11, wherein the sealed package comprises a transparent portion.

18. The method of claim 11, wherein the food product is not fully cooked after being exposed to the hot temperatures.

19. A method for packaging a food product, the method comprising:
providing the food product;
removing debris from the food product;
washing the food product with ozonated water;
deactivating enzymes throughout the food product by raising an internal temperature of the food product to between about 165 degrees Fahrenheit and about 185 degrees Fahrenheit;
sealing the food product in a barrier package, wherein an internal cavity of the sealed barrier package comprises between about 1.5 percent and about 10 percent oxygen, by volume;
exposing the sealed package to hot temperatures between about 165 degrees Fahrenheit and about 285 degrees Fahrenheit to kill microbes within the sealed package; and
chilling the sealed package directly after the sealed package is exposed to the hot temperatures.

20. The method of claim 19, wherein the internal temperature of the food product is raised to between about 165 degrees Fahrenheit and about 185 degrees Fahrenheit for a period of time between 30 and about 90 seconds.
